(19) United States
(12) Patent Application Publication
(10) Pub. No.: US 2014/0285109 A1
(43) Pub. Date: Sep. 25, 2014

(54) LIGHT EMITTING DEVICE DRIVER CIRCUIT AND CONTROL CIRCUIT AND CONTROL METHOD THEREOF

(71) Applicants: Chia-Wei Liao, Zhubei City (TW); Leng-Nien Hsiu, Zhubei City (TW)

(72) Inventors: Chia-Wei Liao, Zhubei City (TW); Leng-Nien Hsiu, Zhubei City (TW)

(73) Assignee: RICHTEK TECHNOLOGY CORPORATION, Zhubei City (TW)

(21) Appl. No.: 14/214,747

(22) Filed: Mar. 15, 2014

Related U.S. Application Data
(60) Provisional application No. 61/804,014, filed on Mar. 21, 2013.

(51) Int. Cl. H05B 33/08

(52) U.S. Cl. CPC H05B 33/0815
USPC 315/291

(57) ABSTRACT

The present invention discloses a light emitting device driver circuit and a control circuit and a control method thereof. The light emitting device driver circuit converts an input voltage to an output voltage, and provides an output current to a light emitting device circuit. The present invention detects whether the output voltage exceeds a predetermined level, and if no, the regulation target of the output current is set to a relatively higher current to fast charge an output capacitor; if yes, the output current is regulated to a desired target, wherein the relatively higher current is higher than the desired target.

### CROSS REFERENCE

The present invention claims priority to U.S. 61/804,014, filed on Mar. 21, 2013.

### BACKGROUND OF THE INVENTION

1. Field of Invention

The present invention relates to a light emitting device driver circuit, and a control circuit and a control method thereof; particularly, it relates to such light emitting device driver circuit, and control circuit and control method thereof which are capable of fast charging an output capacitor at a starting stage.

2. Description of Related Art

FIG. 1 shows a schematic diagram of a prior art light emitting diode (LED) driver circuit 100. As shown in FIG. 1, the LED driver circuit 100 drives an LED circuit 10. The LED driver circuit 100 includes a control circuit 110, a power stage circuit 120, and a feedback circuit 130. The control circuit 110 is connected to the feedback circuit 130 to receive a feedback signal FB which is related to an output current lout. The control circuit 110 generates an operation signal GATE according to the feedback signal FB, to operate a power switch of the power stage circuit 120 such that an input voltage Vin is converted to an output voltage Vout, and an output current Iout is provided to the LED circuit 10. The brightness of the LED circuit 10 is controlled by the output current Iout. If the LED driver circuit 100 is equipped with a dimming function, it can reduce the brightness of the LED circuit 10 to less than full brightness by reducing the regulation target of the output current Iout. As shown in FIG. 1, the control circuit 110 has a pin ACTL which receives a dimming control signal, wherein the dimming control signal can indicate or adjust the regulation target of the output current Iout. The power stage circuit 120 may be a synchronous or asynchronous buck, boost, inverting, buck-boost, inverting-boost, or flyback power stage circuit as shown in FIGS. 2A-2K.

In the aforementioned prior art, when the LED circuit 10 starts to turn ON from an OFF condition, the power stage circuit 120 needs to charge an output capacitor C until a voltage drop across the output capacitor C exceeds a sum of the forward bias voltages of all LEDs connected in series in the LED circuit 10; then, the LED circuit 10 turns ON to illuminate. Therefore, there is a delay time from a user switching ON the LED circuit 10 until the LED circuit 10 actually turning ON to illuminate; the LED circuit 10 does not immediately illuminate as the user turns ON a lighting switch. In the prior art LED driver circuit 100, a charging current Ic generated by the power stage circuit 120 for charging the output capacitor C is positively correlated with the output current Iout. (In the feedback control loop in which the control circuit 110 generates the operation signal GATE according to the feedback signal FB to control the output current Iout, it is assumed that the output capacitor C is already charged, i.e., it is assumed that Iout=Itotal, wherein Itotal is total supply current generated by the power stage circuit 120. Therefore, in the starting stage when the output capacitor C requires to be charged, the charging current Ic is positively correlated with the total supply current Itotal, i.e., when the regulation target of the output current Iout is higher, the total supply current Itotal is correspondingly higher, and the charging current Ic is also correspondingly higher.) Generally, when the LED driver circuit 100 is equipped with a dimming function, the brightness setting in the starting stage is kept the same as the brightness setting in a last turned OFF stage; therefore, when the LED circuit 10 is set at a lower brightness, the regulation target of the output current Iout is correspondingly lower, and the output capacitor C will require more time to be charged. The lower the brightness setting is, the longer the charging time will be. Thus, the user needs to wait for a long delay time in the starting stage until the LED circuit 10 turns ON to illuminate.

In view of above, the present invention proposes a light emitting device driver circuit, and control circuit and control method thereof which can fast charge an output capacitor at a starting stage, such that the delay time for turning ON a light emitting device circuit is shortened.

### SUMMARY OF THE INVENTION

From one perspective, the present invention provides a light emitting device driver circuit including: a power stage circuit, for operating at least one power switch therein according to an operation signal to convert an input voltage to an output voltage, and to provide an output current to a light emitting device circuit; an output capacitor, which is coupled to the output voltage; and a control circuit, which is coupled to the power stage circuit, for generating the operation signal according to a feedback signal related to the output current and according to information related to the output voltage; wherein when the output voltage does not exceed a predetermined level, the power stage circuit is controlled to fast charge the output capacitor, and when the output voltage exceeds the predetermined level, the power stage circuit is controlled to regulate the output current to a desired target, wherein before the power stage circuit starts a present operation or in a last turned OFF stage of the light emitting device circuit, there is a previous setting for the output current which corresponds to a preset charging current to the output capacitor in a condition that the output capacitor requires to be charged, and the power stage circuit fast charges the output capacitor with a relatively higher current which is higher than the preset charging current.

In one preferable embodiment, the predetermined level is equal to or lower than a threshold conduction forward bias of the light emitting device circuit, and the predetermined level is preferably higher than or equal to 90% of the threshold conduction forward bias, and is lower than 100% of the threshold conduction forward bias.

In one preferable embodiment, the control circuit controls the power stage circuit to regulate the output current to the desired target, and the control circuit further adjusts the desired target according to a dimming control signal when the output voltage exceeds the predetermined level.

In one preferable embodiment, the output capacitor is fast charged by increasing a regulation target of the output current.

In one preferable embodiment, the control circuit adjusts the regulation target of the output current or the predetermined level according to temperature information.

From another perspective, the present invention provides a light emitting device control circuit, for generating an operation signal to control a power stage circuit such that an input voltage is converted to an output voltage across an output capacitor and an output current is provided to a light emitting device circuit, the light emitting device control circuit including: a selection circuit, for selecting a first reference level or a fast charging reference; a first comparison circuit, for comparing an output of the selection circuit with a feedback signal related to the output current, and generating a first comparison result; an operation signal generation circuit, for generating the operation signal according to the first comparison result; and a second comparison circuit, for comparing a voltage sensing signal related to the output voltage with a second reference level, and generating a second comparison result to determine whether the first reference level or the fast charging reference is selected by the selection circuit; wherein the light emitting device control circuit sets a regulation target of the output current according to the fast charging reference to fast charge the output capacitor when the output voltage does not exceed a predetermined level corresponding to the second reference level, and sets a regulation target of the output current according to the first reference level when the output voltage exceeds the predetermined level.

In one preferable embodiment, the first reference level is adjustable.

In one preferable embodiment, the fast charging reference or the second reference level is adjustable.

From another perspective, the present invention provides a light emitting device control method, for operating a power stage circuit to convert an input voltage to an output voltage across an output capacitor, and to provide an output current to a light emitting device circuit, the light emitting device control method including: detecting whether the output voltage exceeds a predetermined level; setting a regulation target of the output current to a relatively higher current for fast charging the output capacitor when the output voltage does not exceed the predetermined level; and regulating the output current at a desired target when the output voltage exceeds the predetermined level, wherein the relatively higher current is higher than the desired target.

In one preferable embodiment, the desired target is a setting of the output current before the power stage circuit starts a present operation or in a last turned OFF stage of the light emitting device circuit, and the setting of the output current corresponds to a relatively lower brightness of the light emitting device circuit, and wherein the relatively higher current corresponds to a maximum brightness of the light emitting device circuit.

In one preferable embodiment, the relatively higher current is a maximum current allowed to be supplied by the power stage circuit.

In one preferable embodiment, the method further includes: adjusting the desired target according to a dimming control signal when the output voltage exceeds the predetermined level.

In one preferable embodiment, the method further includes: adjusting the relatively higher current of the output current or the predetermined level according to temperature information.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art light emitting diode (LED) driver circuit 100.

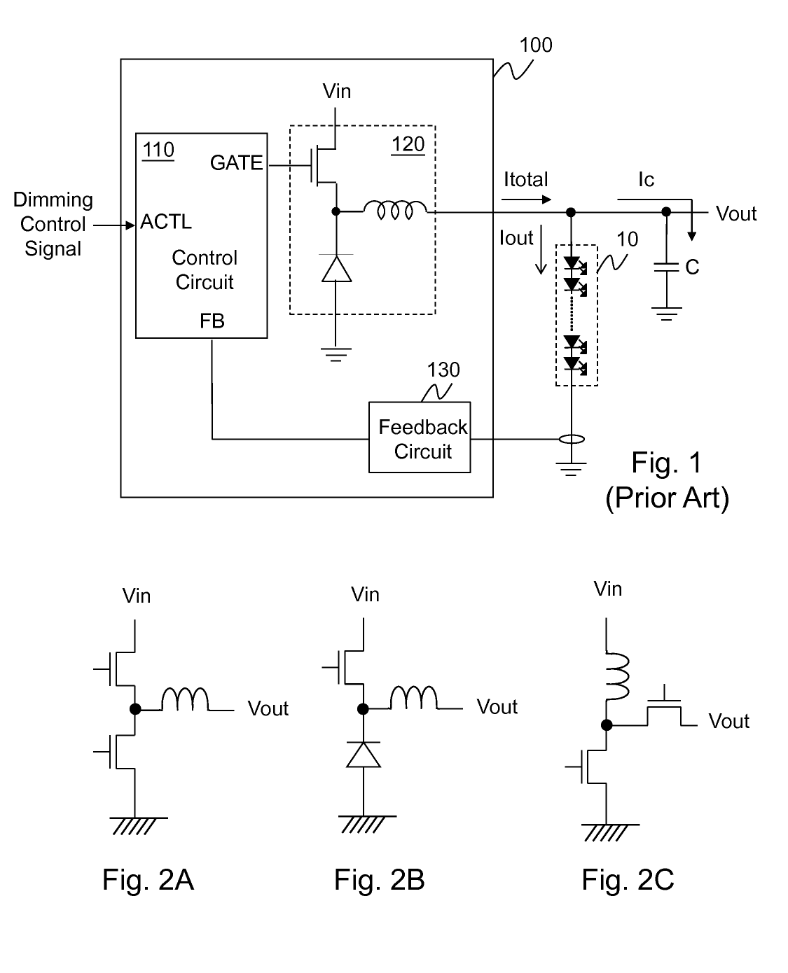

FIGS. 2A-2K show synchronous and asynchronous buck, boost, inverting, buck-boost, inverting-boost, and flyback power stage circuits.

FIG. 3 shows a first embodiment the present invention.

FIGS. 4A-4B show two embodiments of the light emitting device control circuit of the present invention.

FIG. 5 shows an embodiment of a light emitting device control method according to the present invention.

### DESCRIPTION OF THE PREFERRED EMBODIMENTS

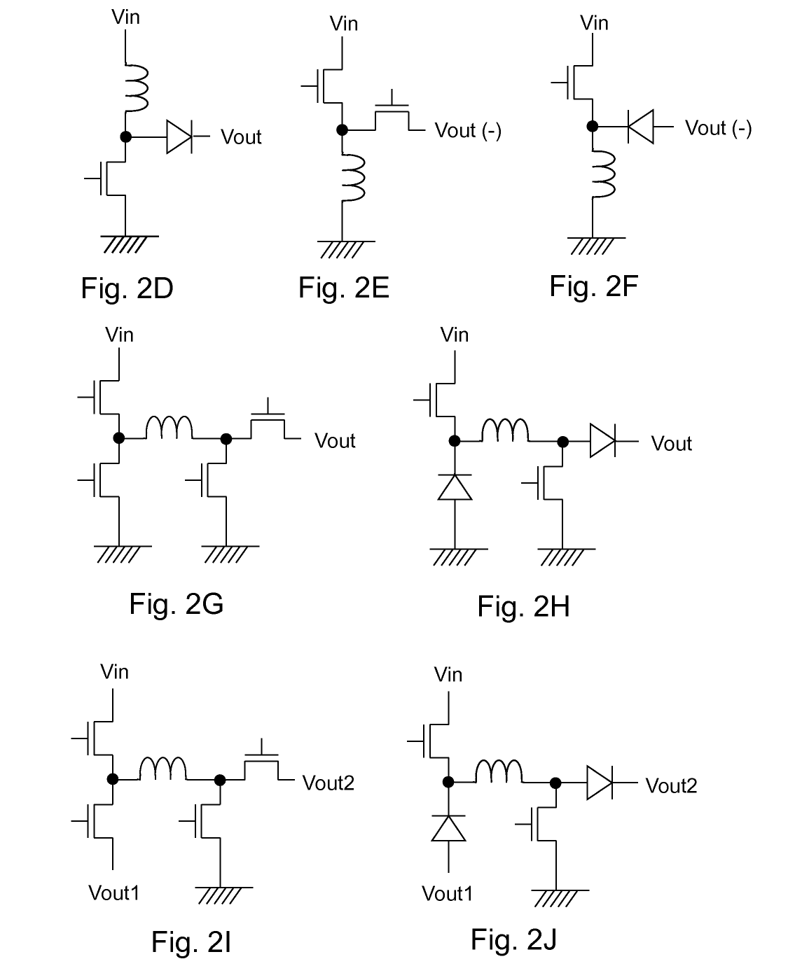

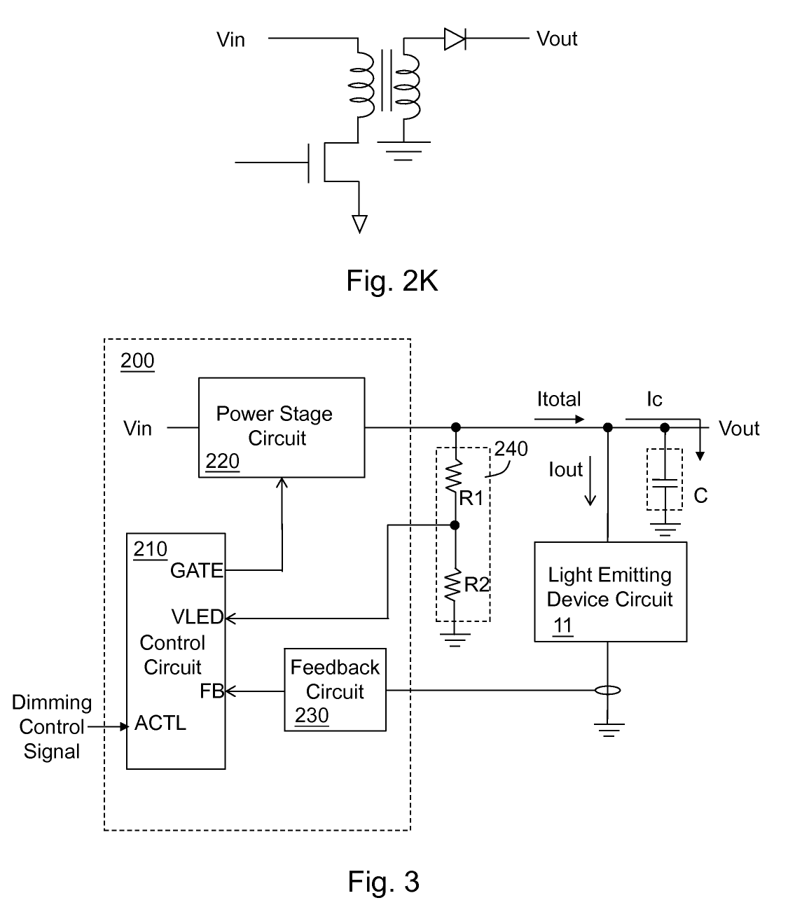

Please refer to FIG. 3 for a first embodiment according to the present invention. As shown in FIG. 3, a light emitting device driver circuit 200 includes a control circuit 210, a power stage circuit 220, a feedback circuit 230, and may further include an output voltage sensing circuit 240 (the output voltage sensing circuit 240 may be omitted if the control circuit 210 can withstand a high voltage level; in this case the control circuit 210 can directly receive the output voltage Vout). In a normal operation mode, the control circuit 210 generates an operation signal GATE according to a feedback signal FB, to operate at least one power switch (not shown in FIG. 3, referring to FIGS. 2A-2K; if the power stage circuit 220 includes two or more power switches, the operation signal GATE can correspondingly include plural operation signals, as well known by those skilled in the art, so details thereof are omitted here) of the power stage circuit 220, such that an input voltage Vin is converted to the output voltage Vout and an output current Iout is regulated at a desired target; the output current Iout is provided to a light emitting device circuit 11. The output capacitor C has an end coupled to the output voltage Vout, and another end coupled to a proper level, such as a ground level. The feedback circuit 230 generates the feedback signal FB according to the output current Iout flowing through the light emitting device circuit 11. The output current Iout is regulated at the desired target by feedback control. The power stage circuit 220 is for example but not limited to the synchronous or asynchronous buck, boost, inverting, buck-boost, inverting-boost, or flyback power stage circuit as shown in FIGS. 2A-2K. The light emitting device circuit 11 includes for example but not limited to one or more LEDs connected in series or in an array, and the light emitting device circuit 11 can further include a passive device or a switch.

Still referring to FIG. 3, the output voltage sensing circuit 240 is coupled to the output voltage Vout, and it generates a divided voltage VLED according to the output voltage Vout. The output voltage sensing circuit 240 includes for example but not limited to resistors R1 and R2 connected in series as shown in the figure. Therefore, the divided voltage VLED is: VLED=Vout×R2/(R1+R2).

The control circuit 210 receives the divided voltage VLED which indicates information related to the output voltage Vout. Note that, the output voltage sensing circuit 240 is not necessarily required and may be omitted if the control circuit 210 can withstand a voltage level of the output voltage Vout (that is, the control circuit 240 can directly receive the output voltage Vout); and the output voltage sensing circuit 240 is not necessarily a voltage divider. If the power stage circuit 220 is the flyback power stage circuit as shown in FIG. 2K, and the reference levels (the ground levels) at different sides of a transformer therein are different, the output voltage sensing circuit 240 can be different, for example but not limited to being an optocoupler.

When the output voltage Vout does not exceed a predetermined level (i.e., the divided voltage VLED does not exceed a level correspondingly), the control circuit 210 enters a fast charging mode to fast charge the output capacitor C; when the output voltage Vout exceeds the predetermined level, the control circuit 210 enters the aforementioned normal operation mode to regulate the output current Iout at the desired target. The “desired target” can be a user setting or a default setting, for example but not limited to a current corresponding to a maximum brightness of the light emitting device circuit 11, or a current corresponding to a user setting in a last turned OFF stage of the light emitting device circuit (such as a brightness setting lower than maximum brightness). In the starting stage, the output voltage Vout gradually increases, and the light emitting device circuit 11 turns ON to illuminate when the output voltage Vout reaches a threshold voltage; this threshold voltage is referred to as a threshold conduction forward bias of the light emitting device circuit 11. By way of example, if the light emitting device circuit 11 includes only LEDs connected in series, then the threshold conduction forward bias is a sum of all the forward bias voltages of the LEDs connected in series. If the light emitting device circuit 11 includes other devices besides the LED, the threshold conduction forward bias is the aforementioned sum plus voltage drops of the other devices. In one embodiment, the aforementioned predetermined level (as a reference to determine whether the control circuit 210 operates in the fast charge mode or the normal operation mode) may be set equal to or lower than the threshold conduction forward bias of the light emitting device circuit. In a preferable embodiment, the aforementioned predetermined level may be set higher than or equal to 90% of the threshold conduction forward bias, and lower than 100% of the threshold conduction forward bias.

According to the present invention, to fast charge the output capacitor is for example but not limited to charging the output capacitor C with a relatively higher current allowable till the divided voltage VLED reaches or exceeds a level corresponding to the predetermined level. As explained in the above, the charging current to the output capacitor C is positively correlated with the output current Iout, that is, there is a correlation that a given output current Iout corresponds to a charging current to the output capacitor C (under a condition that the output capacitor has not been fully charged or the voltage across the output capacitor C has not reached a desired level). Assuming that there is a default setting for the output current Iout before the power stage circuit starts operation or the user has set the output current lout by a user setting at a last turned OFF stage of the light emitting device circuit 11, and the default setting or the user setting corresponds to a charging current Ic (off) to the output capacitor C when the output capacitor C still requires to be charged, then the “relatively higher current allowable” is to charge the output capacitor C by a current Ic (fast) higher than the default setting or the user setting, i.e., Ic (fast)>Ic (off). Because the current which charges the output capacitor C is positively correlated with the output current Iout, the current which charges the output capacitor C can be adjusted by adjusting the regulation target of the output current Iout. However, the present invention is not limited to this; for example, the fast charge current can be supplied by conducting another charging path to fast charge the output capacitor C.

The current Ic(fast) may be a constant or variable, such as but not limited to: (1) If the brightness setting in the last turned OFF stage is lower than the maximum brightness setting, the current Ic(fast) for fast charging the output capacitor C may be a current corresponding to the maximum brightness setting. Assuming that the charging current to the output capacitor C corresponding to the maximum brightness setting is Ic(max), this means that if Ic(off)<Ic(max), Ic(fast)=Ic(max). (2) Regardless what the brightness setting in the last turned OFF stage is, the current Ic (fast) for fast charging the output capacitor C may be a current of an allowable maximum that the power stage circuit 220 can supply, such as a maximum current that will not trigger an over current protection (OCP). Assuming that the maximum current is Ic(OCP), this means that no matter what level Ic(off) is, Ic(fast)=Ic(OCP)>Ic(max). (An over current protection sets an allowable upper limit current in a circuit, and when the current reaches the upper limit, a protection mechanism will be triggered, such as shutting down operation of the circuit, if a current flowing through the circuit exceeds the allowable upper limit current. In general, the allowable upper limit current determined by OCP is higher than the current corresponding to the maximum brightness setting of the light emitting device circuit 11.)

In a preferable embodiment, the predetermined level is slightly lower than the threshold conduction forward bias of the light emitting device circuit 11; the purpose of this arrangement is to stop fast charging before the light emitting device circuit 11 starts illuminating. That is, although the present invention intends to shorten the delay time from the user turning on a light switch to the light emitting device circuit starting illuminating as much as possible (by a maximum allowable current which does not cause an undesirable inrush current from damaging the circuitry), this invention also avoids a flicker condition in which the light emitting device circuit starting illuminating by higher brightness and then changing to low brightness.

Besides, in general, the threshold conduction forward bias is related to operation temperature; therefore, in a preferable embodiment, the threshold conduction forward bias is calculated by taking the temperature factor into consideration, and the control circuit adjusts the regulation target of the output current or the fast charging time accordingly. In brief, the relatively higher fast charging current or fast charging time may be adjusted according to the operation temperature.

In one preferable embodiment, when the output voltage Vout exceeds the predetermined level, i.e., in the normal operation mode, the control circuit 210 generates the operation signal GATE further according to an external dimming control signal to adjust the regulation target. In such case where the LED driver circuit provides a dimming function, the present invention is advantageous over the prior art in that, in the prior art, when the prior art LED driver circuit 100 is previously turned OFF at a low brightness setting, in the starting stage of a next turned ON operation, the charging current to the output capacitor C is low because of the low previous setting in the last turned OFF stage. Therefore, the output capacitor C requires a relatively longer period to be fully charged, and the user needs to wait perceivably for the LED circuit 10 to illuminate. In contrast, the present invention can shorten the delay time, because no matter the LED driver circuit 200 is previously turned OFF at a low brightness setting or a high brightness setting, the present invention charges the output capacitor C by a high current until the output voltage Vout exceeds the predetermined level. This is one of the advantages of the present invention over the prior art.

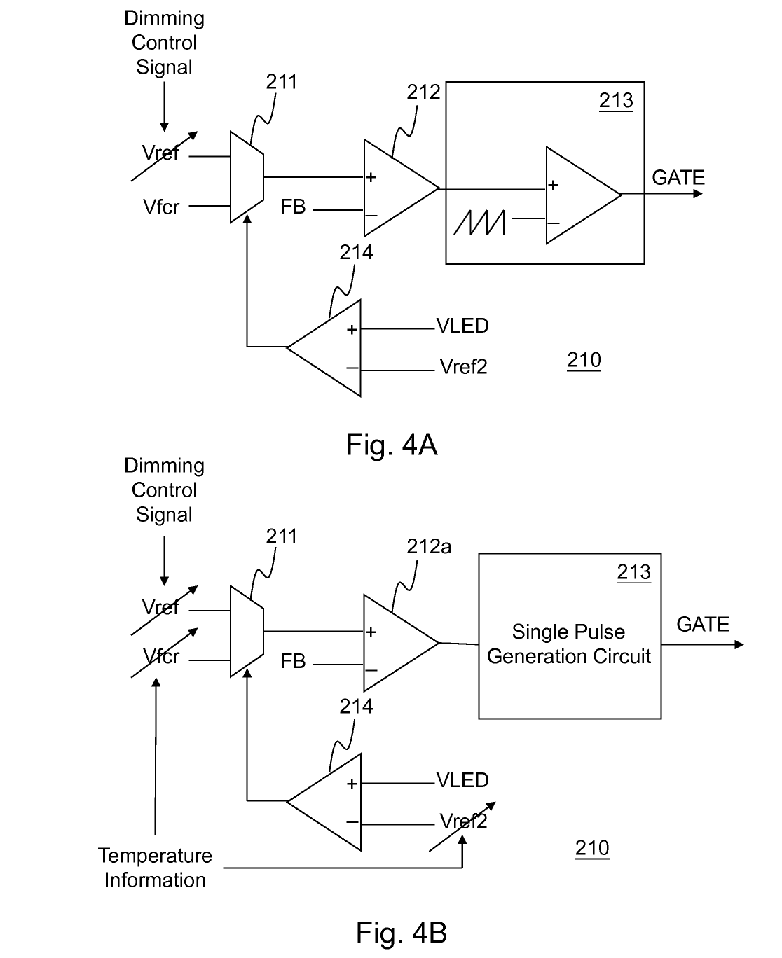

FIG. 4A shows an embodiment of the light emitting device control circuit according to the present invention. As shown in the figure, the control circuit 210 includes a selection circuit 211, an operational amplifier 212, an operation signal generation circuit 213, and a comparator 241. In the normal operation mode, the selection circuit 211 selects an output reference level Vref1, such that the operational amplifier 212 generates an error signal by comparing the feedback signal FB and the output reference level Vref1, and the operation signal generation circuit 213 generates the operation signal GATE according to the error signal. The operation signal generation circuit 213 can generate the operation signal GATE according to the error signal in various ways, and the present invention is not limited to any specific form thereof. For example, the operation signal generation circuit 213 may compare the error signal with a ramp signal to generate the operation signal GATE. The ramp signal may be generated by the control circuit 210 internally, or generated according to an inductor current (referring to FIGS. 2A-2K). In the fast charging mode of the starting stage, the selection circuit 211 selects a fast charging reference Vfcr, such that the operational amplifier 212 generates the error signal by comparing the feedback signal FB and the fast charging reference Vfcr, and the operation signal generation circuit 213 generates the operation signal GATE according to the error signal. In this embodiment, the output capacitor C may be charged with a charging current higher than the current Ic(off) by temporarily increasing the regulation target of the output current Iout (corresponding to the fast charging reference). As explained in the above, the control circuit 210 assumes Iout=Itotal (referring to FIG. 3) as it generates the operation signal GATE according to the feedback signal FB, and when the output capacitor C requires to be charged, the charging current Ic to the output capacitor C is positively correlated with current Itotal, so if the regulation target of the output current Iout is higher, the current Itotal is higher, and the charging current Ic to the output capacitor C is higher. The comparator 214 compares the divided voltage VLED with a reference level Vref2, wherein the reference level Vref2 corresponds to the aforementioned predetermined level of the output voltage Vout. The selection circuit 211 selects the reference level Vref1 or the fast charging reference Vfcr according to comparison result. If the light emitting device driver circuit 200 is equipped with the dimming function, the control circuit 210 may achieve the dimming function for example by adjusting the output reference level Vref1 according to a dimming control signal. However, the method to achieve the dimming function is not limited to this, and the present invention is not limited to any of the dimming methods.

FIG. 4B shows an embodiment of the control circuit according to the present invention. As shown in the figure, the control circuit 210 includes the selection circuit 211, a comparison circuit 212a, the operation signal generation circuit 213, and the comparator 214. This embodiment intends to show that the operation signal GATE is not limited to being generated by the method shown in the previous embodiment. In this embodiment, the comparison circuit 212a may include an operational amplifier or a comparator (as well known to one skilled in this art, an operational amplifier and a comparator are the same circuit except that the output is generated in an analog form or in a digital form; therefore, in the present invention, they are generically referred to as a comparison circuit). The operation signal generation circuit 213 in this embodiment may be a signal pulse generation circuit. When the output signal of the comparison circuit 212a meets a preset level condition, the signal pulse generation circuit generates a single pulse with a fixed length as the operation signal GATE. Similar to the previous embodiment, the selection circuit 211 selects the output reference level Vref1 in the normal operation mode, and selects the fast charging reference Vfcr in the fast charging mode. This embodiment also shows that the fast charging reference and/or the reference level Vref2 may be adjusted according to the temperature information (the temperature information is generated by for example but not limited to a resistor which is sensitive to the temperature, not shown). That is, the higher fast charging current (or the higher regulation target of the output current), or the fast charging time, may be adjusted according to the operation temperature.

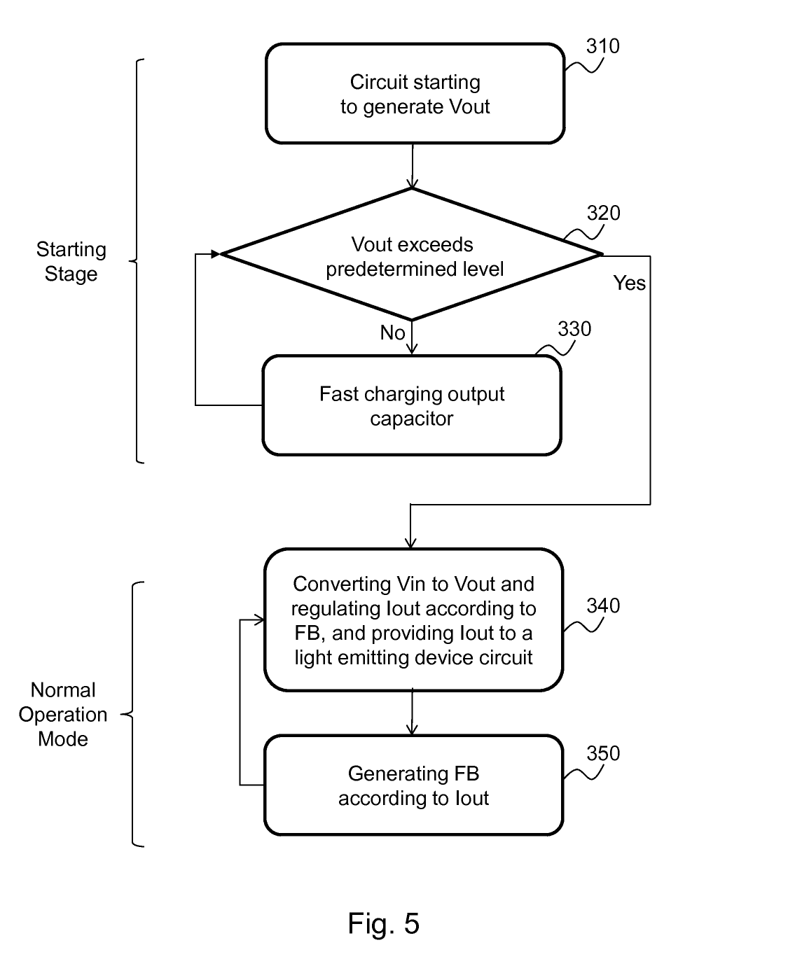

FIG. 5 shows an embodiment of the control method of the light emitting device according to the present invention. As shown in the figure, the control method includes the following steps: first, as shown in step 310, the power stage circuit starts to generate the output voltage Vout. Next, as shown in step 320, it is determined whether the output voltage Vout exceeds the predetermined level or not. If the output voltage Vout does not exceed the predetermined level, as shown in step 330, the output capacitor C is fast charged by a fast charging current, for example by setting the regulation target of the output current Iout to a relatively higher current. If the output voltage Vout exceeds the predetermined level, as shown in step 340, the power stage circuit converts the input voltage Vin to the output voltage Vout and regulates the output current Iout to a desired target according to the feedback signal FB, and the output current Iout is provided to the light emitting device circuit. The desired target for example corresponds to a maximum brightness setting, or a user's brightness setting in the last turned OFF stage. Next, as shown in step 350, the feedback signal FB is generated according to the output current Iout, and the output current Iout is steadily regulated at the desired target and provided to the light emitting device circuit as shown by steps 340 and 350.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device or circuit which does not substantially influence the primary function of a signal can be inserted between any two devices or circuits shown to be in direct connection in the embodiments, such as a switch or the like, so the term “couple” should include direct and indirect connections. For another example, the light emitting device that is applicable to the present invention is not limited to the LED as shown and described in the embodiments above, but may be any current-control device. For another example, that the light emitting device circuit is connected to the power stage circuit is not limited to a direct connection between the light emitting device circuit and the output node of the power stage circuit, but may be an indirect connection condition (with another circuit inserted in between). For another example, the positive and negative input terminals of the comparison circuits (comparators or operational amplifiers) are interchangeable, with corresponding amendments of the circuits processing these signals. For another example, a Smith trigger changes its output level when its input signal reaches a predetermined level, so it can function as a comparator with one input terminal. In view of the foregoing, the spirit of the present invention should cover all such and other modifications and variations, which should be interpreted to fall within the scope of the following claims and their equivalents.

What is claimed is:

1. A light emitting device driver circuit comprising:
a power stage circuit, for operating at least one power switch therein according to an operation signal to convert an input voltage to an output voltage, and to provide an output current to a light emitting device circuit;
an output capacitor, which is coupled to the output voltage; and
a control circuit, which is coupled to the power stage circuit, for generating the operation signal according to a feedback signal related to the output current and according to information related to the output voltage;
wherein when the output voltage does not exceed a predetermined level, the power stage circuit is controlled to fast charge the output capacitor, and when the output voltage exceeds the predetermined level, the power stage circuit is controlled to regulate the output current to a desired target, wherein before the power stage circuit starts a present operation or in a last turned OFF stage of the light emitting device circuit, there is a previous setting for the output current which corresponds to a preset charging current to the output capacitor in a condition that the output capacitor requires to be charged, and the power stage circuit fast charges the output capacitor with a relatively higher current which is higher than the preset charging current.

2. The light emitting device driver circuit of claim 1, wherein the predetermined level is equal to or lower than a threshold conduction forward bias of the light emitting device circuit.

3. The light emitting device driver circuit of claim 2, wherein the predetermined level is higher than or equal to 90% of the threshold conduction forward bias, and is lower than 100% of the threshold conduction forward bias.

4. The light emitting device driver circuit of claim 1, wherein the control circuit controls the power stage circuit to regulate the output current to the desired target, and the control circuit further adjusts the desired target according to a dimming control signal when the output voltage exceeds the predetermined level.

5. The light emitting device driver circuit of claim 1, wherein the output capacitor is fast charged by increasing a regulation target of the output current.

6. The light emitting device driver circuit of claim 5, wherein the control circuit adjusts the regulation target of the output current or the predetermined level according to temperature information.

7. A light emitting device control circuit, for generating an operation signal to control a power stage circuit such that an input voltage is converted to an output voltage across an output capacitor and an output current is provided to a light emitting device circuit, the light emitting device control circuit comprising:
a selection circuit, for selecting a first reference level or a fast charging reference;
a first comparison circuit, for comparing an output of the selection circuit with a feedback signal related to the output current, and generating a first comparison result;
an operation signal generation circuit, for generating the operation signal according to the first comparison result; and
a second comparison circuit, for comparing a voltage sensing signal related to the output voltage with a second reference level, and generating a second comparison result to determine whether the first reference level or the fast charging reference is selected by the selection circuit;
wherein the light emitting device control circuit sets a regulation target of the output current according to the fast charging reference to fast charge the output capacitor when the output voltage does not exceed a predetermined level corresponding to the second reference level, and sets a regulation target of the output current according to the first reference level when the output voltage exceeds the predetermined level.

8. The light emitting device control circuit of claim 7, wherein the predetermined level is equal to or lower than a threshold conduction forward bias of the light emitting device circuit.

9. The light emitting device control circuit of claim 7, wherein the predetermined level is higher than or equal to 90% of the threshold conduction forward bias, and is lower than 100% of the threshold conduction forward bias.

10. The light emitting device control circuit of claim 7, wherein the first reference level is adjustable.

11. The light emitting device control circuit of claim 7, wherein the fast charging reference or the second reference level is adjustable.

12. A light emitting device control method, for operating a power stage circuit to convert an input voltage to an output voltage across an output capacitor, and to provide an output current to a light emitting device circuit, the light emitting device control method comprising:
detecting whether the output voltage exceeds a predetermined level;
setting a regulation target of the output current to a relatively higher current for fast charging the output capacitor when the output voltage does not exceed the predetermined level; and
regulating the output current at a desired target when the output voltage exceeds the predetermined level, wherein the relatively higher current is higher than the desired target.

13. The control method of claim 12, wherein the desired target is a setting of the output current before the power stage circuit starts a present operation or in a last turned OFF stage of the light emitting device circuit, and the setting of the output current corresponds to a relatively lower brightness of the light emitting device circuit, and wherein the relatively higher current corresponds to a maximum brightness of the light emitting device circuit.

14. The control method of claim 12, wherein the relatively higher current is a maximum current allowed to be supplied by the power stage circuit.

15. The control method of claim 12, wherein the predetermined level is equal to or lower than a threshold conduction forward bias of the light emitting device circuit.

16. The control method of claim 15, wherein the predetermined level is higher than or equal to 90% of the threshold conduction forward bias, and is lower than 100% of the threshold conduction forward bias.

17. The control method of claim 12, further comprising: adjusting the desired target according to a dimming control signal when the output voltage exceeds the predetermined level.

18. The control method of claim 12, further comprising: adjusting the relatively higher current of the output current or the predetermined level according to temperature information.
